(19) United States
(12) Patent Application Publication
(10) Pub. No.: US 2026/0218551 A1
(43) Pub. Date: Jul. 30, 2026

(54) Systems and Methods for Accurately Marking Fastener Placement for Cabinetry Installation

(71) Applicant: Brian Higgins, Fannin, GA (US)

(72) Inventor: Brian Higgins, Fannin, GA (US)

(21) Appl. No.: 19/464,077

(22) Filed: Jan. 29, 2026

Related U.S. Application Data
(60) Provisional application No. 63/750,846, filed on Jan. 29, 2025.

(51) Int. Cl. E05D 11/00

(52) U.S. Cl. CPC E05D 11/0009

(57) ABSTRACT

A system for accurately marking fastener placement for cabinetry installation. The system includes a primary alignment body having alignment indicia, a pair of independently adjustable marking guide blocks carrying marking projection pins, and removable spacing members configured to establish repeatable vertical reference offsets relative to cabinet carcass boundaries. The adjustable marking guide blocks are positionable to correspond to a fastener pattern of a cabinet hinge, handle, or knob, enabling direct transfer of fastener locations to cabinet carcasses without manual measurement. Interchangeable and/or adjustable calibration spacers may be selectively installed to establish predetermined overlay or reveal distances, and in certain embodiments slidable extension bod(ies) and associated guide rails permit adjustment of backset and depth positioning for face-frame, inset, and full-overlay configurations. A method of using the system in connection with hinge or hardware components. Hardware is aligned with the primary alignment body, the marking guide blocks are set to match the hardware fastener pattern, vertical and overlay offsets are established, and the system is pressed against one or more cabinet carcasses to repeatedly transfer precise fastener location marks without re-measurement.

### CROSS REFERENCE TO RELATED APPLICATIONS

To the full extent permitted by law, the present United States Non-Provisional Patent Application hereby claims priority to and the full benefit of, U.S. Provisional Application No. 63/750,846, filed Jan. 29, 2025, entitled “Systems and Methods for Accurately Marking Fastener Placement for Cabinetry Installation”, which is incorporated herein by reference in its entirety.

### FIELD OF THE DISCLOSURE

The present disclosure relates generally to cabinetry installation tools, and more particularly to a jig system for accurately marking fastener locations on a cabinet carcass for mounting cabinet hinges and related hardware.

### BACKGROUND OF THE DISCLOSURE

The accurate installation of cabinet hinges and related mounting hardware requires precise positioning of fastener locations on a cabinet carcass. Improper vertical offset, inconsistent spacing between mounting screws, or deviation from intended reference edges may result in misaligned doors, uneven reveals, binding during operation, or premature hardware wear. In many installations, cabinet doors are prepared at a cabinet shop or factory, while mounting plates or carcass-side hardware are installed on-site after transport. In those installations where doors are factory-prepared using automated hinge boring equipment, the cabinet carcass itself typically requires field marking and installation of hinge mounting plates or related hardware. Accordingly, accurate carcass-side marking remains a critical installation step. Numerous jig devices and template kits have been developed to assist installers in locating hinge components. Many such tools are directed primarily toward drilling or marking hinge cup recesses in cabinet doors. Other devices provide drill guides or marking gauges for certain mounting configurations. Known approaches generally fall into several categories.

A first category involves conventional jigs that employ pivoting arms, hinged members, or rotating linkages that position relative to a cabinet edge. These devices may include predefined hole patterns or drilling guides corresponding to particular hinge types. While such arrangements may assist in aligning certain hinge components, they often require repeated repositioning, locking, and adjustment for each hinge location and may be optimized for a limited range of hinge geometries. Additionally, some systems use fixtures which are configured to temporarily carry a hinge or mounting plate during installation, rather than providing a broadly adjustable carcass-side marking platform.

Other commercially available jig kits utilize crossbars, threaded fasteners, sliding members, and adjustable striking pins to establish spacing between mounting points. Although such systems may offer multi-axis adjustability, they may involve numerous tightening operations, may be physically cumbersome and/or unwieldy to maneuver, may require iterative centering steps, and often requires a recalibration or resent step between hinge marking and/or installation placements. This may lead to frustrating user experiences and cost additional time between marking and/or installations, particularly where a jig must be repeatedly reconfigured for each hinge location and where a reference relationship is not maintained from cabinet boundary to cabinet boundary. This may increase setup time and introduce cumulative tolerance error across repeated installations. Because multiple interacting components may be tightened and loosened during setup, tolerance stack-up and inadvertent drift may occur during repeated use, especially in some implementations, including implementations lacking a boundary-referenced indexing condition that is locked and therefore automatically repeatably re-established during each marking operation.

Still other template-style tools emphasize drilling operations on the door-side hinge cup rather than marking fastener locations on the cabinet carcass. While these systems may facilitate door preparation, they may not provide a simplified, boundary-referenced indexing structure relative to upper and lower carcass edges for repeatable mounting plate placement. In such cases, installers may still be required to measure and transfer dimensions from the door to the cabinet opening manually.

In many known devices, repeatability across multiple cabinet carcasses depends upon re-measuring distances from cabinet boundaries, manually centering components, re-aligning cross members, or re-indexing the jig for each hinge position. Additionally, some systems are optimized for workshop or industrial environments rather than streamlined on-site installation by professional installers or skilled homeowners. Cabinet hinges are available in numerous configurations, including but not limited to traditional European-style concealed hinges, ⅜-inch overlay hinges, ½-inch overlay hinges, full-overlay hinges, partial-overlay hinges, inset hinges, face-frame hinges, frameless hinges, single-screw mounting plate hinges, double-screw mounting plate hinges, clip-on hinge systems, screw-on mounting plate systems, and other commercially available hinge assemblies. Further hinge-related hardware may include cam-adjustable mounting plates, face-frame adapter plates, and alternative mounting plate geometries that vary by manufacturer and product line. Screw spacing patterns and mounting plate geometries may vary across manufacturers and hinge families. Many prior jig systems are configured for only certain hinge types or limited screw patterns and may not provide a broadly adaptable solution across multiple hinge configurations.

Furthermore, marking jigs and gauges historically have required installers to mark each hinge location individually, often performing measurement, alignment, marking, and rechecking steps for both upper and lower hinge positions of each cabinet opening. These steps must be repeated for every cabinet carcass within an installation. The cumulative time required for such processes may be significant, particularly in multi-cabinet installations such as kitchens or commercial millwork projects. Even minor inconsistencies may become visually apparent across adjacent cabinet doors where uniform reveals are desired.

Accordingly, deficiencies in the art may include at least: (a) reliance on pivoting or hinged members requiring repeated adjustment; (b) multi-component crossbar assemblies with numerous threaded fasteners; (c) lack of a simplified boundary-referenced vertical indexing structure; (d) requirement for repeated measuring between hinge placements; (e) limited compatibility across diverse hinge screw patterns; (f) installation procedures that require separate marking operations for each hinge location; and (g) reliance on fixtures optimized for hinge holding or mounting plate carrying rather than carcass-side fastener marking.

Therefore, there remains a need for a simplified jig system that references directly from cabinet carcass boundaries and permits repeatable fastener marking with minimal mechanical adjustment. Such a system would preferably be adaptable to a broad range of hinge mounting plates and screw patterns, reduce setup time, and enable an installer to mark multiple cabinet carcasses without repeated recalibration. Such a system would further preferably function as a universal carcass-side marking platform independent of any single hinge family or manufacturer-specific mounting plate geometry. As may be realized by those having ordinary skill in the art upon review of the Detailed Description and accompanying Drawings, the system disclosed herein addresses these needs and represents an advancement in cabinetry hardware positioning guides by providing improved compatibility, repeatability, efficiency, and installation simplicity relative to existing jig systems and related tools.

### SUMMARY OF THE DISCLOSURE

The present disclosure provides a boundary-referenced fastener marking system for cabinetry carcasses that improves repeatability, simplifies setup, and reduces mechanical complexity relative to conventional jig kits. Unlike prior jig systems, as may be described above, that are optimized primarily for door-side hinge cup drilling or limited hinge plate geometries, the disclosed system can be specifically structured for carcass-side hinge mounting plate placement across a broad range of hinge configurations. In particular, various aspects of the disclosed system provide a carcass-side marking approach that may be applied without requiring the jig to carry the hinge or mounting plate during attachment.

In one aspect, the invention may provide a system having a primary alignment body configured to be positioned against a cabinet carcass within a guide region defined between an upper boundary and a lower boundary. The primary alignment body can be configured to combine with a pair of adjustable marking guide blocks movably coupled to the primary alignment body. A marking projection pin can be carried by each adjustable marking guide block and configured to transfer a fastener location directly to a cabinet surface. Then, an upper spacing member can be removably coupled to the primary alignment body to establish a first vertical reference offset and a lower spacing member can be removably coupled to the primary alignment body at a spaced location corresponding to the first vertical reference offset to define a repeatable boundary-referenced vertical distance. In certain embodiments, calibration spacers and/or an adjustable spacer block may be selectively installed to establish predetermined overlay distances corresponding to common hinge specifications, including but not limited to ⅜-inch overlay, ½-inch overlay, full overlay, inset configurations, and other reveal-based installations. Such adjustable spacer blocks may be continuously adjustable (rather than limited to discrete preset values), may be configured to adjusted at specific increments (e.g., ⅜-inch, ½-inch, etc.) or calibration spacers may be selected instead based on a desired reveal and may enable consistent repetition of offsets across multiple cabinet openings.

In contrast to conventional pivot-arm or multi-crossbar systems, the present system of the disclosure establishes a vertical datum relative to cabinet carcass boundaries using removable spacing members that cooperate with the primary alignment body. Once the adjustable marking guide blocks are positioned to correspond to a desired hinge fastener pattern, the system may be repeatedly positioned between upper and lower carcass boundaries without re-measuring or re-centering. The primary alignment body and spacing members can then cooperate to create a consistent boundary-referenced placement condition. The adjustable marking guide blocks permit lateral positioning corresponding to hinge specifications, while the marking projection pins transfer fastener locations directly to the cabinet carcass surface. In this manner, a single initial configuration may enable an installer to mark multiple cabinet carcasses within an installation without further adjustment, thereby significantly reducing cumulative setup time. This repeatability may be particularly advantageous in multi-cabinet installations where uniformity of reveals and hinge alignment is desired.

Advantages of the disclosed system may include many of the following features and/or advantages as may be recognized by those having ordinary skill in the art. First, a simplified mechanical architecture relative to multi-crossbar or pivoting assemblies can be achieved. This in turn may result in a reduced setup time after initial configuration as well as consistent repeatable placement between defined cabinet boundaries. This may also prevent the need and/or provide the elimination of repeated measurement during successive installations during various methods of the disclosure, meaning improved installation accuracy across multiple cabinet carcasses. In certain implementations, initial setup may be accomplished in approximately one minute, after which hinge locations may be marked in a matter of seconds per cabinet opening. By reducing repeated measuring and iterative centering operations, the disclosed system may reduce cumulative tolerance error across an installation.

Through these structural and functional improvements, the disclosed system and method of use advances the state of cabinetry installation tools by providing a compact, boundary-indexed, repeatable marking system optimized for practical installation environments. The system may be constructed from a single or multiple durable materials including but not limited to injection-molded reinforced polymers, such as glass-reinforced nylon, in combination with hardened steel marking elements and metallic guide components, thereby providing durability suitable for repeated professional use, especially when housed in a comprehensive kit having multiple sub-housings for organizational, storage, and transportation purposes, as may be recognized by those having ordinary skill in the art. In certain embodiments, the system may further include integrated alignment indicia and/or a level vial to assist in consistent positioning during marking. Through use of the disclosed system, various objectives may be achieved either independently or simultaneously, depending on the need being met for those having ordinary skill in the art of cabinetry installation.

One such objective may be to provide a jig system for accurately marking fastener locations on a cabinet carcass. Accurate fastener placement is critical to ensuring proper hinge alignment, door reveal consistency, and long-term performance of cabinetry installations. Even minor deviations in mounting hole placement may result in door misalignment, binding, or uneven gaps. Repeated mistakes may result in unsightly gouges in cabinetry that need repair or even replacement. By providing a system specifically structured to transfer fastener locations directly to the cabinet carcass, the invention reduces reliance on manual measurement and visual estimation, thereby improving installation precision. The disclosed system can be adaptable to numerous hinge types, including but not limited to European-style concealed hinges, ⅜-inch overlay hinges, ½-inch overlay hinges, partial overlay hinges, full-overlay hinges, inset hinges, face-frame hinges, frameless hinges, single-screw mounting plate hinges, double-screw mounting plate hinges, clip-on hinge systems, and screw-on mounting plate systems. Other hinge-related hardware including, but not limited to, face-frame adapter plates, cam-adjustable mounting plates, and alternative mounting plate geometries may likewise be accommodated due to the adjustable spacing capability of the marking guide blocks.

Another objective may be to provide a boundary-referenced alignment system that establishes fastener placement relative to upper and lower carcass boundaries. Many conventional jig kits require repeated measuring from cabinet edges or iterative repositioning of adjustable components. In contrast, referencing directly from defined carcass boundaries allows the installer to establish a repeatable vertical reference. This boundary-indexed approach improves consistency across multiple cabinets and reduces cumulative positioning error. Because cabinet door hinges are typically installed at consistent setback distances from the door edge regardless of door height, the disclosed boundary-referenced approach allows corresponding carcass placement to be standardized without individualized measurement for each door length.

Yet another potential objective may be to provide a primary alignment body that cooperates with removable spacing members to establish repeatable vertical reference offsets. Rather than relying on pivoting arms, threaded centering mechanisms, or complex crossbar assemblies, the disclosed system uses removable spacing members to define known offsets in a structurally simple manner. Once configured, the alignment condition may be replicated repeatedly without recalibration. This reduces setup time and enhances reliability during successive installations. In certain embodiments, the system may be reversibly oriented to accommodate left-swinging or right-swinging door configurations without additional modification.

Yet another objective may be to provide adjustable marking guide blocks that are laterally positionable relative to a primary alignment body to correspond to varying hinge fastener patterns. Cabinet hinge manufacturers may specify different fastener spacing patterns depending on hinge type or overlay configuration. The adjustable marking guide blocks allow the installer to tailor the system to a particular hinge specification while maintaining the vertical boundary reference. This adaptability assists to improve the utility of the system across multiple hinge types without increasing structural complexity. The system may further include centerline scales or centering rulers to facilitate alignment for hinges lacking a central reference point.

Yet another objective may be to provide marking projection pins carried by adjustable guide blocks for directly transferring fastener locations to a cabinet carcass surface. Direct transfer of the fastener location reduces the need for drill bushings or intermediate templates. The marking projection pins allow an installer to establish precise pilot locations prior to drilling, minimizing bit wandering and alignment error. This improves both efficiency and finished installation quality. In alternative configurations, a single marking element may be temporarily repositioned to mark single-screw hinge plates, cabinet pulls, or cabinet knobs.

It is another object of the invention to reduce the need for repeated measurement between successive hinge placements. It is a further object of the invention to reduce mechanical complexity relative to multi-crossbar, pivoting-arm, or multi-fastener jig assemblies. Conventional adjustable jig systems may involve numerous threaded fasteners, sliding cross members, or pivoting linkages that must be adjusted and locked into place. Increased mechanical complexity can introduce tolerance stack-up, wear, and misalignment over time. The present invention achieves repeatable placement with fewer interacting components, thereby improving durability and ease of use. After initial adjustment of the marking guide blocks to match a hinge fastener pattern, the installer may apply the jig across multiple cabinets without re-centering or recalculating offsets. This repeatability is particularly valuable in multi-cabinet installations where uniformity is critical. The system thereby enhances both efficiency and aesthetic consistency. The disclosed system may further be configured to mark cabinet pulls and handles having single-screw or dual-screw configurations by repositioning the marking guide blocks to match handle spacing and using the same boundary-referenced indexing principles. Accordingly, the disclosed system may function as a general-purpose carcass and door hardware marking platform using the same adjustable marking architecture.

By eliminating the need for multiple and/or routine adjustments during a single cabinetry installation, another objective to improve installation speed while maintaining placement accuracy across multiple cabinetry installations may be satisfied. Installation efficiency is an important practical consideration for professional installers and contractors. By simplifying alignment steps and reducing mechanical adjustments, the invention shortens setup and application time. At the same time, the structural boundary referencing maintains placement accuracy. In many installations, an entire kitchen or multi-cabinet project may be marked after a single jig configuration, thereby substantially reducing labor time relative to traditional marking methods.

Finally, the disclosure seeks to provide a compact jig system suitable for professional on-site use. Many conventional jig assemblies are optimized for workshop or industrial environments and may be cumbersome in field conditions. The present invention is structured to provide the necessary alignment and marking functionality within a streamlined form factor. This enhances portability and usability in practical installation settings. To this end, variations of a “standard” jig may vary depending on the types of installations and/or versatility that may be needed. In certain embodiments, expanded or “deluxe” jig configurations may incorporate additional components such as slidable extension bodies, linear guide rails, auxiliary spacing members, and selectively lockable adjustment features. Such configurations may permit increased depth reach, accommodation of face-frame cabinetry, support for inset or full-overlay hinge plates, or compatibility with front-mounted hinge systems and alternative mounting plates. These expanded assemblies may provide enhanced adaptability for specialized installations while retaining the boundary-referenced alignment principles described herein. However, assemblies simplified to be more efficiently manufactured and/or assembled may exist, which offer much, but not all of the features and/or convenience of the standard assembly, which are also included within the bounds of the disclosure herein. Accordingly, the disclosure contemplates a range and/or spectrum of jig systems, including but not limited to simplified, streamlined standard, and modular deluxe embodiments, each configured to address a broader range of cabinetry installation scenarios than existing solutions in the marketplace and state of the art. Collectively, these embodiments provide various universally adaptable carcass-side marking platform not limited to a single hinge family or screw pattern. In this context, “universal” refers to adjustability across multiple commercially available hinge geometries and mounting patterns, but may not require compatibility with every conceivable hinge product.

The foregoing illustrative summary, as well as other exemplary objectives and/or advantages of the disclosure, and the manner in which the same are accomplished, are further explained within the following Detailed Description and its accompanying Drawings.

### BRIEF DESCRIPTION OF THE DRAWINGS

The present disclosure will be better understood by reading the Detailed Description with reference to the accompanying drawings, which are not necessarily drawn to scale, and in which like reference numerals denote similar structure and refer to like elements throughout, and in which:

FIG. 1 is a perspective view of an exemplary embodiment of a boundary-referenced fastener marking system of the disclosure;

FIGS. 2A-B illustrate the system of FIG. 1 in a plan view and a perspective view;

FIGS. 3A-E illustrate the system of FIG. 1 in a series of configurations to perform the method of the disclosure;

FIGS. 4A-B illustrate the system of FIG. 1 in relation to various hinge configurations;

FIG. 5 illustrates several representative cabinet and hinge configurations;

FIGS. 6A-B illustrate a potentially preferred embodiment of the system of the disclosure;

FIGS. 7A-C illustrate an embodiment of the system having a simplified construction; and

FIG. 8 is a method flowchart showing exemplary steps of the disclosed method.

It is to be noted that the drawings presented are intended solely for purposes of illustration and are not intended to limit the disclosure to the exact details of construction shown, except insofar as such details may be deemed essential to the claimed subject matter.

### DETAILED DESCRIPTION

In describing the exemplary embodiments of the present disclosure, as illustrated in the accompanying figures, specific terminology is employed for the sake of clarity. The present disclosure, however, is not intended to be limited to the specific terminology so selected, and it is to be understood that each identified component includes all technical equivalents that operate in a similar manner to accomplish similar functions. The embodiments described herein are provided for illustrative purposes and are not intended to be exhaustive or limiting. Structural and functional variations may be implemented without departing from the scope of the appended claims. As used herein, directional terms such as “upper,” “lower,” “vertical,” “horizontal,” “front,” “rear,” and similar relational terms are used with reference to the cabinetry carcass and installation orientation shown in the figures, and are not intended to require any particular absolute orientation unless expressly stated. Similarly, terms such as “cabinet carcass,” “cabinet body,” “cabinet frame,” and “cabinet structure” may be used interchangeably to refer to the structural enclosure or framework to which hinges or hardware are mounted. References to “hinge,” “hinge plate,” “mounting plate,” and related hardware are intended to include various commercially available hinge configurations, including overlay, inset, full-overlay, face-frame, frameless, and front-mounted hinge systems. The disclosure contemplates use of the described system with any such hinge or hardware configuration unless expressly limited. As further used herein, reference characters Fx may represent forces, including, e.g., rotational force Fr and actuation force Fa, respectively, and any reference character Fx may represent a generalized applied force in the direction illustrated by any arrows thereof.

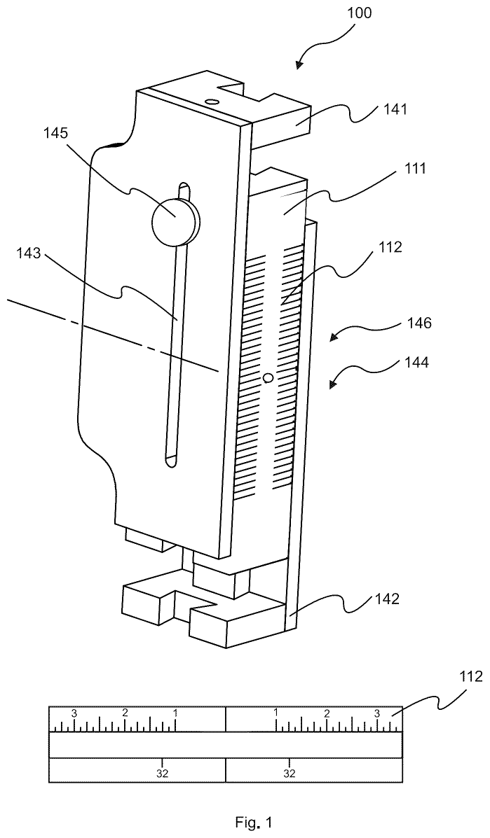

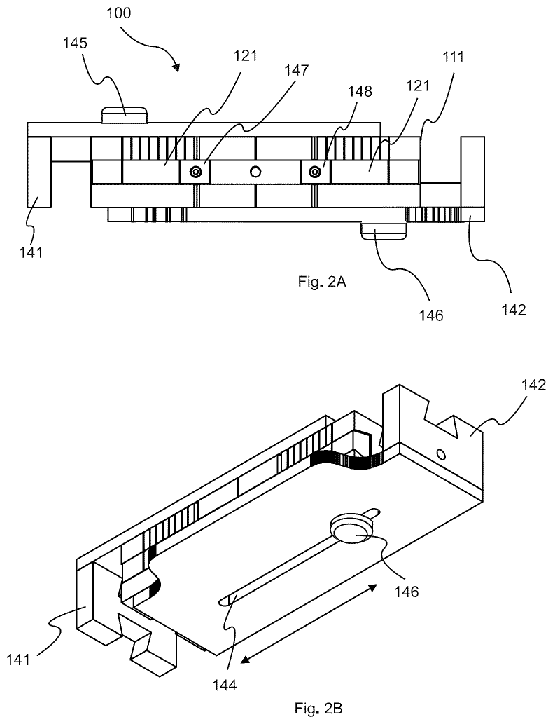

Referring now first specifically to FIG. 1, therein is illustrated a perspective view of an exemplary embodiment of a system for accurately marking fastener placement for a cabinetry carcass of a cabinetry installation, namely marking system assembly 100. Marking system assembly 100 may generally comprise primary alignment body 111, a pair of adjustable marking guide blocks 121, marking projection pins 131 carried by adjustable marking guide blocks 121, upper spacing member 141, and lower spacing member 142. In the embodiment illustrated, adjustable marking guide blocks 121 may be identical and/or chiral (mirror images of one another), though differences in construction may exist depending on hinge type or installation requirements. Collectively, these components cooperate to provide a boundary-referenced fastener marking system configured to be positioned within a guide region of a cabinet carcass between an upper boundary and a lower boundary thereof. In certain embodiments, marking system assembly 100 may be reversibly oriented to accommodate left-swinging or right-swinging door configurations without structural modification.

With respect to primary alignment body 111, this component may function as the structural base of marking system assembly 100. Primary alignment body 111 may define at least one longitudinal guide channel, slot, rail, or track within which adjustable marking guide blocks 121 are movably coupled. Primary alignment body 111 may further include alignment indicia, such as engraved or laser-etched scales, centerline markings, overlay reference indicators, graduated measurement lines, or other visual alignment features that assist in positioning relative to a cabinet hinge. Such alignment indicia may permit initial calibration of adjustable marking guide blocks 121 using a hinge as a template and thereafter allow replication of the spacing without further measurement. In certain embodiments, primary alignment body 111 may additionally include accessory features such as a level vial, integrated tool holder, or storage recesses. Primary alignment body 111 may be formed of injection-molded polymer, reinforced polymer, aluminum, steel, composite materials, the like and/or combinations thereof. It is contemplated that primary alignment body 111 may be manufactured as a single-piece component or as a multi-piece assembly secured together via fasteners, adhesives, welding, press-fit engagement, the like and/or combinations thereof.

Turning now to adjustable marking guide blocks 121, each adjustable marking guide block 121 may be slidably received within a corresponding guide region of primary alignment body 111. Adjustable marking guide blocks 121 may be independently movable relative to one another along a longitudinal axis of primary alignment body 111 in order to correspond to varying hinge fastener spacing patterns. In certain embodiments, adjustable marking guide blocks 121 may be positioned by referencing a hinge mounting plate directly against primary alignment body 111 and aligning marking projection pins 131 with hinge fastener openings prior to locking. In certain embodiments, adjustable marking guide blocks 121 may include friction-fit engagement, detent mechanisms, threaded locking elements, cam locks, set screws, spring-biased retainers, or other securing means to selectively fix a desired position. Adjustable marking guide blocks 121 may be formed of polymeric, metallic, composite, or other durable materials suitable for repeated mechanical use in installation environments.

Carried by each adjustable marking guide block 121 may be marking projection pin 131. Marking projection pin 131 may be configured to transfer a fastener location directly to a cabinet carcass surface when primary alignment body 111 is pressed thereagainst. Marking projection pin 131 may comprise a sharpened element, such as a pointed screw, hardened steel pin, punch element, insert, or replaceable marking tip. In certain embodiments, marking projection pin 131 may be threadedly engaged within adjustable marking guide block 121 to permit removal, replacement, or height adjustment. Height adjustment may allow compensation for finish thickness, surface irregularities, or differing cabinet materials. Materials suitable for marking projection pin 131 may include hardened steel, tool steel, carbide, alloys thereof, the like and/or combinations thereof to resist deformation during repeated use. It is contemplated that marking projection pin 131 may be permanently installed or removably installed within adjustable marking guide block 121.

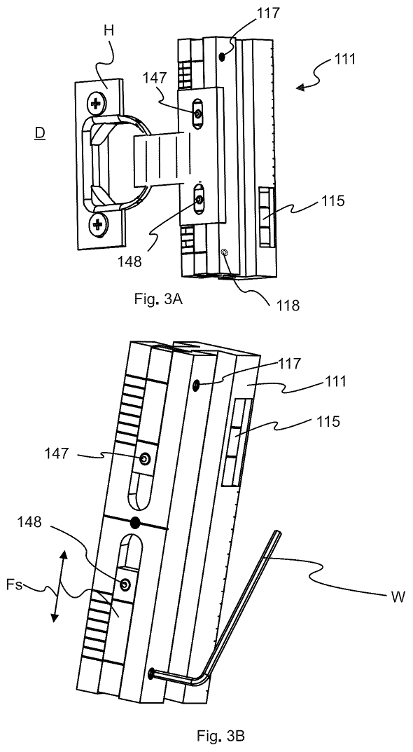

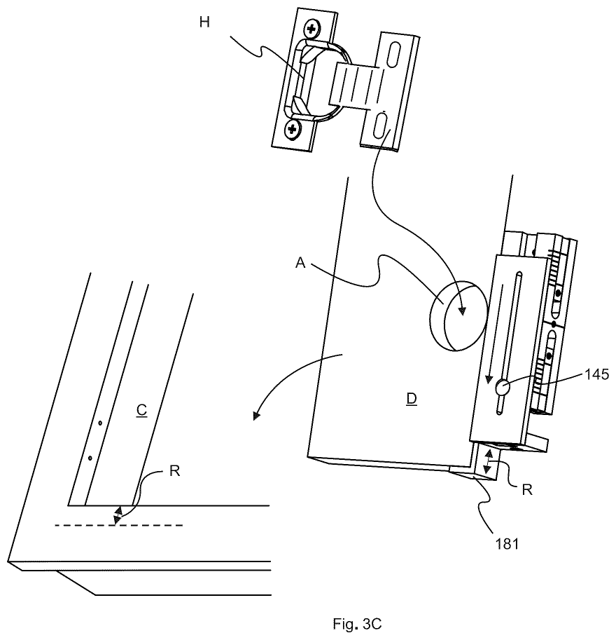

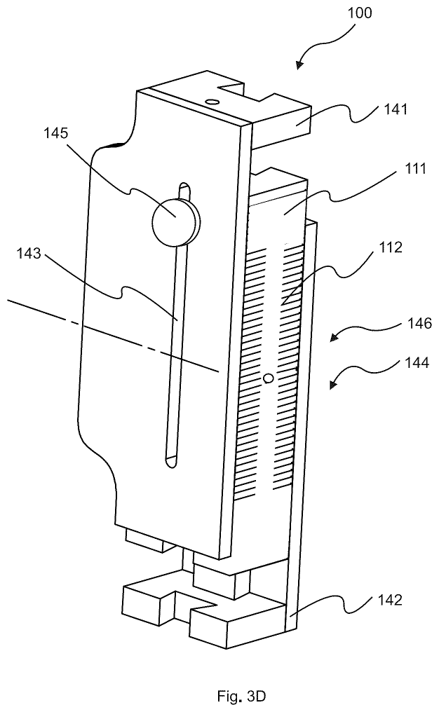

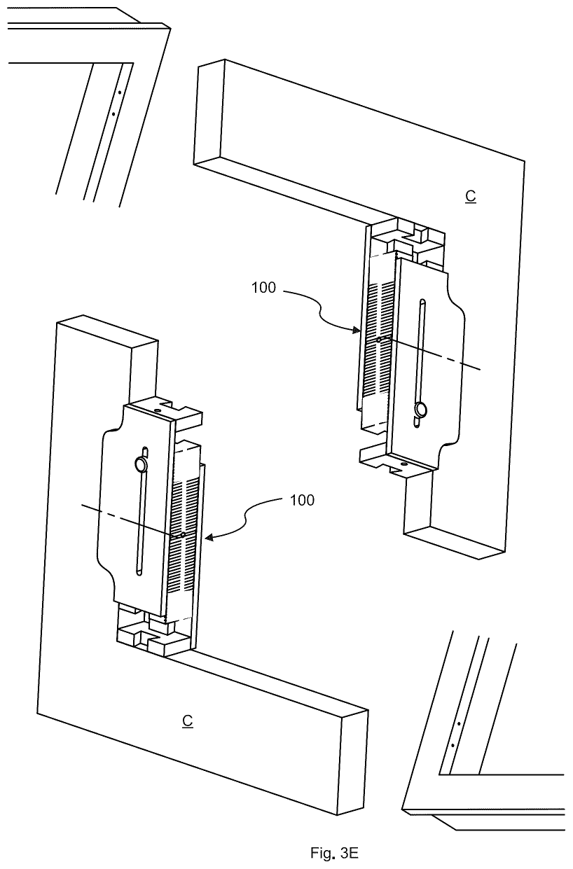

With respect to upper spacing member 141 and lower spacing member 142, these components may be removably coupled to primary alignment body 111 to establish vertical reference offsets relative to cabinet carcass boundaries. Upper spacing member 141 may be configured to abut an upper boundary of the guide region of the cabinet carcass, while lower spacing member 142 may be configured to abut a lower boundary thereof. In certain embodiments, reveal selection member 181 (see, e.g., FIG. 3C) may be selectively installed between spacing members 141, 142 and a reference surface to define a predetermined reveal length R corresponding to an overlay, inset, or reveal configuration of door D relative to cabinet carcass C. Additionally, in certain embodiments, upper spacing member 141 and lower spacing member 142 may be slidably received within recesses, slots, or channels formed in primary alignment body 111. Securing mechanisms for these spacing members may include threaded locking fasteners, thumbscrews, cam locks, snap-fit features, magnetic engagement, friction-fit engagement, the like and/or combinations thereof. The cooperative positioning of upper spacing member 141 and lower spacing member 142 relative to primary alignment body 111 establishes a repeatable vertical datum between the upper boundary and lower boundary of the cabinet carcass.

In operation, once adjustable marking guide blocks 121 are positioned to correspond to a fastener pattern of a cabinet hinge, marking system assembly 100 may be positioned such that upper spacing member 141 or lower spacing member 142 abuts a respective boundary of the cabinet carcass. Primary alignment body 111 may then be pressed against the cabinet carcass surface, causing marking projection pins 131 to transfer precise fastener locations. Thereafter, marking system assembly 100 may be repositioned at another cabinet carcass while maintaining the same configuration of adjustable marking guide blocks 121 and spacing members 141, 142, thereby enabling consistent repeated placement without re-measurement. Such repeatability may permit marking of multiple cabinet openings after a single initial calibration.

Although FIG. 1 may be understood to illustrate a “standard” embodiment comprising primary alignment body 111, adjustable marking guide blocks 121, marking projection pins 131, upper spacing member 141, and lower spacing member 142, the disclosure contemplates additional modular embodiments incorporating extension components, auxiliary spacing elements, additional guide structures, locking mechanisms, and/or other structural features. Such variations may enhance reach, depth adjustment, compatibility with face-frame cabinetry, inset installations, full-overlay hinge systems, and alternative mounting plate configurations, while maintaining the boundary-referenced alignment principles described herein.

As contemplated herein, the disclosure may include a spectrum of related marking assemblies including a standard marking system assembly 100, an expanded marking assembly 200, and a streamlined marking assembly 300. Standard marking system assembly 100 may comprise primary alignment body 111, adjustable marking guide blocks 121, marking projection pins 131, upper spacing member 141, lower spacing member 142, and optionally reveal selection member 181 and/or an adjustable spacer block, thereby providing a boundary-referenced lateral and vertical indexing architecture suitable for most frameless and overlay installations. Expanded marking assembly 200 may incorporate all structural elements of marking system assembly 100 and further include extension body 201, one or more linear guide rails 211 (including rail guide 212 where provided), extension locking fastener knob 232, and optional extension spacing members or stop structures, thereby enabling adjustable backset positioning, increased depth reach, face-frame compatibility, inset configurations, full-overlay hinge systems, and alternative mounting plate geometries requiring forward or rearward offset relative to primary alignment body 111. In contrast, streamlined marking assembly 300 may omit sliding guide channels and removable spacer blocks and instead include main body 311 carrying hardened marking spikes, rotating support member 341, threaded overlay adjustment bolt 346 having a washer engagement surface for cabinet face referencing, and independently adjustable threaded vertical reveal rods 343 and 345, thereby providing continuous threaded overlay and reveal control within a compact machined structure. While the mechanical implementations differ among assemblies 100, 200, and 300, each embodiment maintains the core boundary-referenced marking methodology described herein, namely hinge reference establishment, overlay and reveal calibration, and repeatable transfer of fastener locations relative to cabinet carcass boundaries.

Referring now to FIG. 2A, therein is illustrated a plan view of marking system assembly 100. From this perspective, primary alignment body 111 may be seen defining longitudinal guide channel 144 extending along adjustment path 146. Adjustable marking guide blocks 121 are shown positioned at spaced locations along guide channel 144, illustrating independent lateral positioning capability relative to primary alignment body 111. Alignment indicia 112 may be positioned adjacent guide channel 144 to provide graduated reference markings for repeatable placement of adjustable marking guide blocks 121. In certain embodiments, alignment indicia 112 may include mirrored scale markings to facilitate symmetrical positioning of marking projection pins 131 relative to a centerline of primary alignment body 111.

FIG. 2B illustrates a perspective view of primary alignment body 111 with adjustable marking guide blocks 121 partially removed to more clearly illustrate guide channel 144 and associated structural features. Guide channel 144 may comprise a T-slot, dovetail track, linear rail interface, undercut channel, or other mechanically retaining structure configured to constrain adjustable marking guide blocks 121 to linear movement along adjustment path 146 while resisting vertical displacement. In certain embodiments, guide channel 144 may include detent recesses or indexing features to provide tactile feedback during positioning. Upper spacing member 141 and lower spacing member 142 may also be seen in relation to primary alignment body 111, illustrating their relative positioning and removable coupling structure. Collectively, FIGS. 2A-2B demonstrate the structural cooperation between primary alignment body 111 and adjustable marking guide blocks 121 to enable controlled lateral positioning corresponding to hinge fastener spacing patterns.

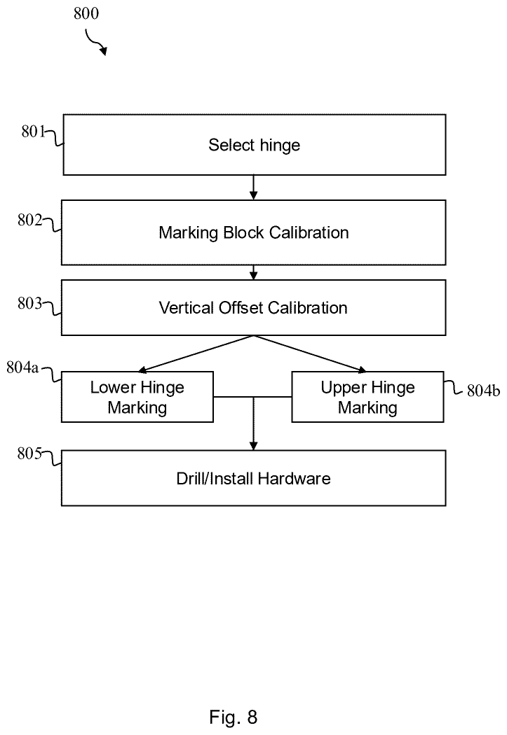

Turning now to FIG. 3A, therein is illustrated marking system assembly 100 during initial hinge calibration relative to hinge H and door D. In this stage, corresponding to step 801 of method 800 (see FIG. 8), hinge H is selected and positioned relative to primary alignment body 111. Door D may be present as a reference element to confirm hinge centerline orientation and overlay configuration, including reveal length R relative to cabinet carcass C. Adjustable marking guide blocks 121 are shown in a loosened condition, permitting lateral movement along primary alignment body 111. Wrench W may be used to loosen or tighten threaded locking elements associated with adjustable marking guide blocks 121. In this configuration, hinge H may be pressed against primary alignment body 111 to align hinge fastener openings with marking projection pins 131 prior to locking.

Turning to step 802 of method 800 (Marking Block Calibration), as further illustrated in FIG. 3A, marking projection pins 131 carried by adjustable marking guide blocks 121 may be individually positioned to correspond to screw openings of hinge H. In certain embodiments, hinge H may include an adjustment screw or central reference point that is aligned with centerline indicia 112 defined on primary alignment body 111. Adjustable marking guide blocks 121 may then be secured in place using Wrench W to tighten threaded locking elements. This establishes the lateral spacing of marking projection pins 131 to match the selected hinge configuration without external measurement.

FIG. 3B illustrates continued execution of step 802 of method 800, wherein alignment indicia 112 on primary alignment body 111 may be used to confirm symmetrical positioning of adjustable marking guide blocks 121 relative to a centerline. In embodiments lacking a central hinge reference, alignment may be achieved by referencing scale markings and matching equal offsets from the centerline. During adjustment, adjustable marking guide blocks 121 may be translated along primary alignment body 111 by applying sliding force Fs in a longitudinal direction. Sliding force Fs may represent a manually applied force Fx sufficient to overcome frictional resistance or detent engagement within guide channel 144. Once the desired spacing is achieved, locking mechanisms may again be tightened to secure the position.

Turning now to FIG. 3C, the system progresses to step 803 of method 800 (Vertical Offset Calibration). In this embodiment, upper spacing member 141 and lower spacing member 142 are positioned relative to primary alignment body 111 to establish a vertical reference offset corresponding to a selected overlay, inset, or reveal condition defined by reveal length R for door D (having aperture A) relative to cabinet carcass C. Reveal selection member 181 may be temporarily positioned against door D or a reference edge to define the desired reveal length R. Additionally, reveal selection member 181 may be selected from a plurality of interchangeable reveal members provided within a kit associated with marking system assembly 100. Alternatively, reveal selection member 181 may be an adjustable spacing block, which may be adjusted to various lengths either continuously (any length within a range) or incrementally adjustable according to standard reveal sizing, as may be understood by those having ordinary skill in the art. In embodiments where multiple reveal selection members 181 are available in a kit for a user to select or where an incrementally adjustable reveal selection member 181 is provided, available and/or adjustable lengths of reveal selection member 181 may correspond to a predetermined reveal length R, such as ⅜-inch overlay, ½-inch overlay, full-overlay, inset spacing, or other commonly specified reveal dimensions. Upon selection, reveal selection member 181 may be removably installed between primary alignment body 111 and a reference edge of door D or cabinet carcass C to establish the intended reveal length R without manual measurement. Leveling guide 115 may be used to confirm proper horizontal orientation prior to securing spacing members 141 and 142. Once upper spacing member 141 and lower spacing member 142 are aligned and locked into position, and reveal selection member 181 has established reveal length R, marking system assembly 100 is fully calibrated for repeated hinge marking operations.

Turning now to FIG. 3D, therein is illustrated marking system assembly 100 in a fully calibrated configuration following completion of step 803 of method 800 (see FIG. 8). In this condition, adjustable marking guide blocks 121 are fixed relative to primary alignment body 111 such that marking projection pins 131 correspond precisely to the fastener spacing pattern of hinge H. Upper spacing member 141 and lower spacing member 142 are likewise secured relative to primary alignment body 111 to establish the predetermined vertical reference offset corresponding to reveal length R of door D relative to cabinet carcass C. Reveal selection member 181, if used during setup, may be removed at this stage. Marking system assembly 100 is thus configured for repeated use without further lateral or vertical adjustment. Leveling guide 115 may optionally be observed to confirm proper orientation prior to marking operations. In this calibrated state, marking system assembly 100 is ready for transfer to a cabinet carcass C for fastener marking.

Turning now to FIG. 3E, therein is illustrated execution of step 804a of method 800 (see FIG. 8), wherein marking system assembly 100 is positioned relative to cabinet carcass C for transfer of fastener locations. In this step, one of upper spacing member 141 or lower spacing member 142 is placed in abutting engagement with a corresponding upper or lower boundary of the cabinet carcass C. A side portion of primary alignment body 111 may be positioned against a vertical cabinet face or stile to ensure proper lateral registration. Once properly seated, an actuation force can be applied to primary alignment body 111 in a direction toward cabinet carcass C. This actuation force may cause marking projection pins 131 to contact and indent the cabinet carcass surface, thereby transferring precise fastener locations corresponding to hinge H upon carcass C.

FIG. 3E further illustrates step 804b of method 800, wherein marking system assembly 100 is repositioned within the same cabinet carcass C to mark an additional hinge location, such as a corresponding upper or lower hinge position. After completing marking at a first boundary, marking system assembly 100 may be translated vertically within the cabinet opening and placed in abutting engagement with the opposite boundary while maintaining the previously established configuration of adjustable marking guide blocks 121 and spacing members 141, 142. A subsequent actuation force Fa is applied to transfer the second set of fastener locations. In this manner, both upper and lower hinge positions may be marked using the same calibrated configuration.

With marking system assembly 100 maintained in the calibrated configuration shown in FIG. 3D, steps 804a and 804b may be repeated across multiple cabinet carcasses C within an installation without re-measurement, recalibration, or re-centering of adjustable marking guide blocks 121. Because reveal length R and hinge spacing have been established during initial calibration (steps 801-803), marking system assembly 100 may be sequentially applied to each cabinet opening to provide consistent, repeatable hinge fastener placement throughout an entire cabinetry installation.

Turning now to FIG. 4A, therein is illustrated marking system assembly 100 configured for use with a dual-screw hinge mounting configuration. In this embodiment, hinge H1 includes two spaced fastener openings corresponding to a conventional two-screw mounting plate arrangement. Adjustable marking guide blocks 121 are positioned along primary alignment body 111 such that marking projection pins 131 align precisely with the two fastener openings of hinge H, as previously calibrated during step 802 of method 800. Reveal selection member 181 (see FIG. 3C) may be selected and/or adjusted to establish reveal length R appropriate for the hinge type, and upper spacing member 141 and lower spacing member 142 may define the vertical datum as described in step 803. Once calibrated, marking system assembly 100 may be pressed against cabinet carcass C in accordance with steps 804a-804b of method 800, transferring two distinct fastener marks simultaneously. This configuration demonstrates the ability of marking system assembly 100 to replicate factory-style hinge plate spacing on multiple cabinet carcasses without re-measurement or re-centering.

FIG. 4B illustrates marking system assembly 100 configured for use with a single-screw hinge mounting configuration. Certain commercially available hinge systems utilize a single central mounting fastener, or alternatively provide optional secondary fasteners depending upon installation requirements. In this embodiment, one adjustable marking guide block 121 may be removed, repositioned, or disabled, and a single marking projection pin 131 may be centrally aligned with a mounting location of hinge H2. In certain embodiments, primary alignment body 111 may include a central marking aperture or selectively repositionable marking element configured for single-screw applications. Calibration may be performed using hinge H directly, as described in step 801-802 of method 800, by aligning the central reference of hinge H with centerline indicia 112 of primary alignment body 111. Once secured, marking system assembly 100 may be positioned against cabinet carcass C using upper spacing member 141, lower spacing member 142, and reveal selection member 181 to establish reveal length R. Application of actuation force Fa transfers a single fastener mark to the cabinet carcass surface.

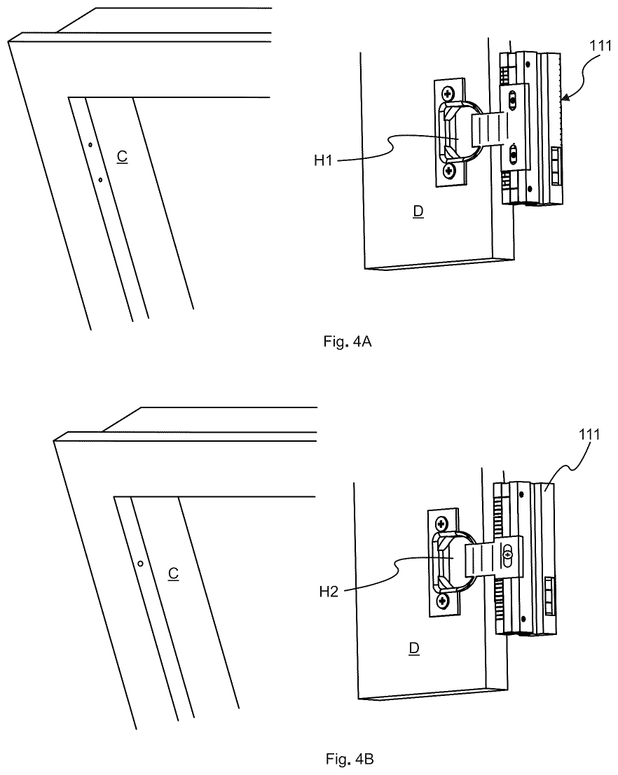

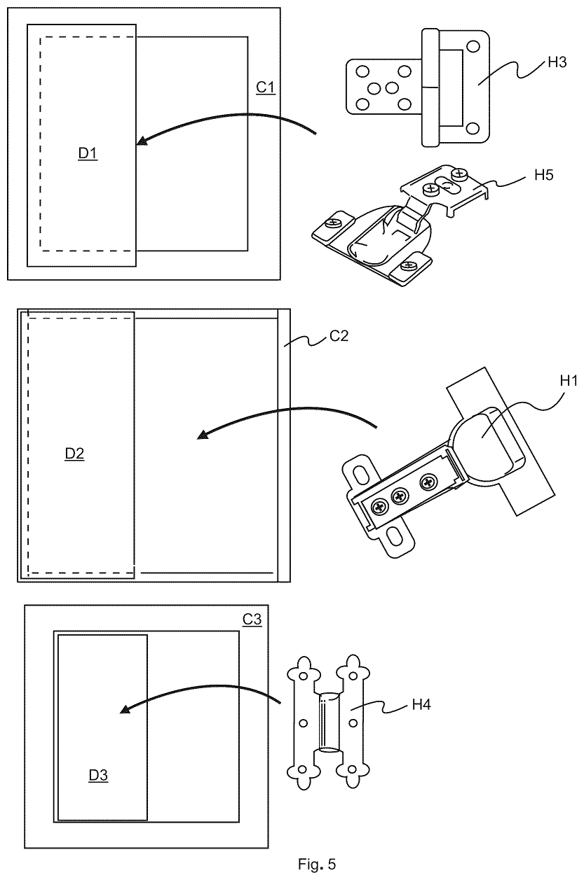

Collectively, FIGS. 4A-4B demonstrate that marking system assembly 100 is not limited to a particular hinge screw pattern or mounting plate geometry. By selectively positioning adjustable marking guide blocks 121 and marking projection pins 131, the system may accommodate dual-screw hinge plates (e.g., hinge H1), single-screw hinge plates (e.g., hinge H2), and alternative mounting configurations (see, e.g., FIG. 5) without modification to primary alignment body 111. This adaptability allows a single calibrated system to service multiple hinge families and manufacturers, including overlay, inset, face-frame, frameless, and specialty hinge systems, while maintaining the boundary-referenced alignment principles described herein.

Turning now to FIG. 5, therein is illustrated a series of representative hinge and cabinet assemblies demonstrating the versatility of marking system assembly 100 across multiple installation configurations. By way of example and not limitation, FIG. 5 may depict overlay hinge assemblies (including ⅜-inch overlay and ½-inch overlay configurations), full-overlay hinges, inset hinge arrangements, face-frame cabinet installations, frameless cabinet constructions, and mounting plates having varied screw spacing patterns or geometries. Although the hinge bodies and mounting plates illustrated may differ in structural form, the calibration methodology of method 800 remains substantially consistent.

With respect to each hinge configuration illustrated in FIG. 5, step 801 of method 800 may involve selecting the appropriate hinge (e.g., H1, H2, or alternate hinge variants, e.g., H3, H4, H5) and aligning it relative to primary alignment body 111 to determine lateral fastener spacing. During step 802, adjustable marking guide blocks 121 are positioned to correspond to the specific fastener pattern of the selected hinge, whether dual-screw, single-screw, offset screw, elongated slot, or alternative plate geometry. In certain hinge types lacking a defined center reference, alignment indicia 112 or centerline scales on primary alignment body 111 may be used to establish symmetrical positioning prior to locking. During step 803, reveal selection member 181 may be selected and/or adjusted according to the intended reveal length R associated with the particular cabinet and hinge assembly shown in FIG. 5. For overlay hinges, reveal selection member 181 may correspond to a predetermined overlay dimension; for inset installations, reveal selection member 181 may define a flush or gap-based offset relative to the cabinet face. Upper spacing member 141 and lower spacing member 142 may then be adjusted to establish the vertical datum relative to cabinet carcass C, regardless of whether the cabinet is of face-frame or frameless construction. Once calibrated, steps 804a-804b of method 800 may be executed identically across the various hinge and cabinet assemblies illustrated in FIG. 5. Marking system assembly 100 may be positioned such that upper spacing member 141 or lower spacing member 142 abuts a corresponding cabinet boundary, and actuation force Fa may be applied to transfer the fastener location(s) to cabinet carcass C. The structural differences between hinge types primarily affect the initial calibration of adjustable marking guide blocks 121 and reveal selection member 181, rather than the marking procedure itself. Accordingly, the operational marking step remains consistent across hinge families.

FIG. 5 thus demonstrates that marking system assembly 100 may function as a universally adaptable carcass-side marking platform. Variations in hinge mounting plate geometry, screw count, screw spacing, overlay dimension, cabinet construction style, or manufacturer specification may alter the calibration inputs of method 800, but do not alter the fundamental boundary-referenced alignment process. Once calibrated for a selected hinge pattern and reveal condition, marking system assembly 100 may be repeatedly applied to multiple cabinet carcasses in a consistent and repeatable manner without re-measurement or iterative repositioning.

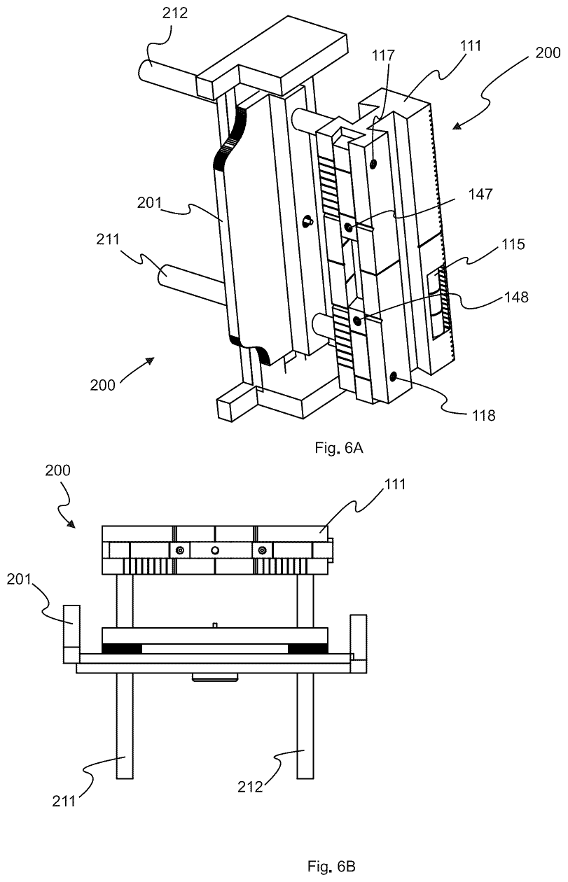

Turning now to FIG. 6A, therein is illustrated a perspective view of expanded marking assembly 200. Expanded marking assembly 200 may incorporate primary alignment body 111, adjustable marking guide blocks 121, marking projection pins 131, upper spacing member 141, lower spacing member 142, and reveal selection member 181 as previously described with respect to marking system assembly 100, but further includes extension body 201 and at least one linear rail guide 211. In certain embodiments, a pair of linear rail guides 211 may be provided in parallel relation to maintain stable translational alignment. Linear rail guides 211 (e.g., rail guide 211 and rail guide 212) may be removably coupled to primary alignment body 111 and extend outwardly therefrom, defining a controlled adjustment axis along which extension body 201 may translate. Extension body 201 may define one or more rail channels configured to slidably receive linear rail guides 211. In this manner, extension body 201 may translate relative to primary alignment body 111 under application force along a generally linear path corresponding to a depth or backset adjustment direction. Extension body 201 may further include a locking interface, such as one or more set screws, thumb screws, cam locks, or threaded fasteners, configured to selectively secure extension body 201 at a desired position along linear rail guides 211. In certain embodiments, alignment indicia may be provided along linear rail guides 211 and/or extension body 201 to visually indicate a selected backset distance. Expanded marking assembly 200 may further include extension stop members coupled to extension body 201 and configured to engage a face frame, cabinet edge, or other structural reference surface. In face-frame installations, extension body 201 may permit marking system assembly 200 to extend beyond a front plane of cabinet carcass C while maintaining proper alignment of marking projection pins 131 relative to hinge mounting geometry. This expanded architecture allows the system to accommodate traditional exterior-mounted hinges, face-frame hinge plates, inset door configurations, full-overlay hinge assemblies, and other mounting patterns requiring increased depth reach relative to frameless cabinetry.

Turning now to FIG. 6B, therein is illustrated expanded marking assembly 200 in an adjusted configuration for a face-frame or extended backset installation. In this embodiment, extension body 201 has been translated along linear rail guides 211 to establish a selected backset dimension relative to primary alignment body 111. Once properly positioned, a locking fastener associated with extension body 201 may be tightened to resist further translation. Thereafter, upper spacing member 141 and lower spacing member 142 may establish and/or maintain vertical positioning as previously described in connection with step 803 of method 800, while adjustable marking guide blocks 121 maintain lateral fastener spacing as established in step 802 of method 800. With expanded marking assembly 200 configured as shown in FIG. 6B, steps 804a and 804b of method 800 may be executed in substantially the same manner as previously described, except that extension body 201 and associated stop structures may now engage a face frame or exterior cabinet surface rather than an interior carcass edge. Application of force against primary alignment body 111 may then cause marking projection pins 131 to transfer fastener locations to cabinet carcass C while the extended geometry maintains proper backset alignment. In this manner, expanded marking assembly 200 enables the same boundary-referenced repeatability principles of marking system assembly 100 while expanding compatibility across additional hinge types, cabinet constructions, and hardware mounting configurations. Accordingly, FIGS. 6A-6B demonstrate that expanded marking assembly 200 provides increased depth adjustability and face-frame compatibility without altering the fundamental lateral calibration and vertical referencing architecture described herein. Once calibrated, expanded marking assembly 200 may likewise be applied repeatedly across multiple cabinet carcasses in accordance with method 800 without re-measurement or re-centering, thereby extending the efficiency and universality of the disclosed marking system.

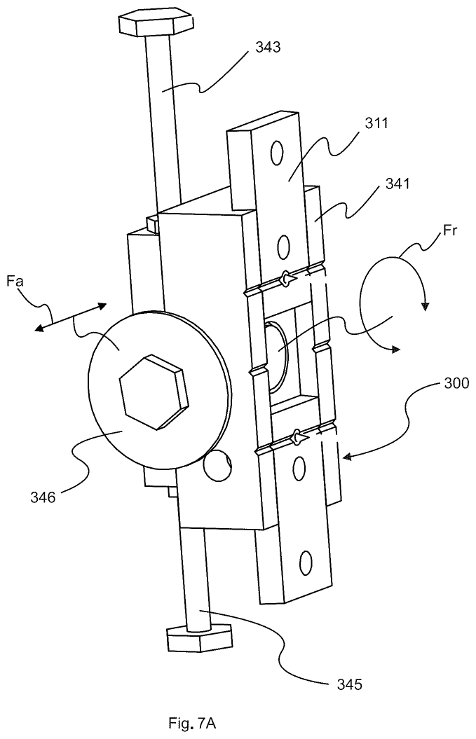

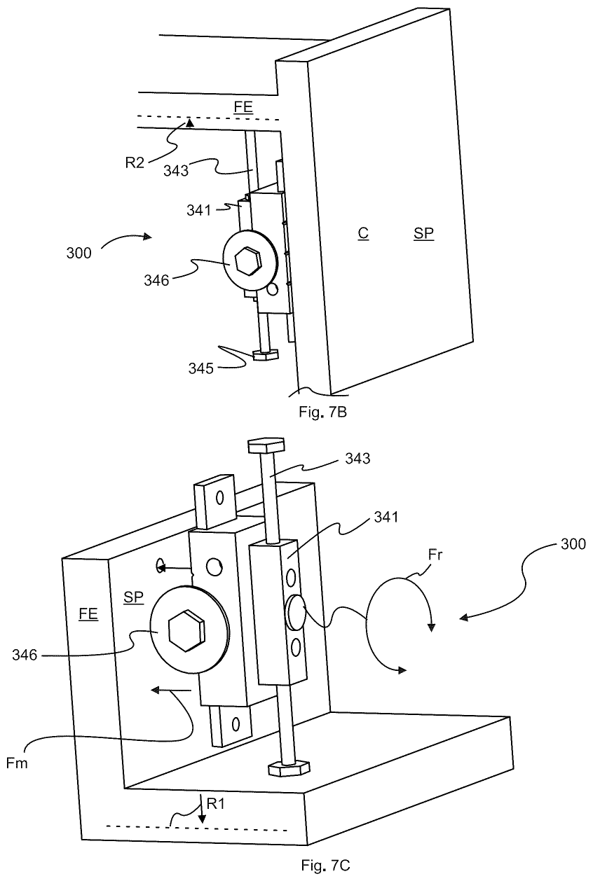

Referring now to FIGS. 7A-7C, there is illustrated an alternate embodiment of the disclosed system, namely streamlined marking assembly 300. Unlike marking system assembly 100 and expanded marking assembly 200, which rely upon sliding guide structures or removable spacing members to establish overlay and reveal geometry, streamlined marking assembly 300 employs threaded mechanical adjustment elements to establish both overlay setback and vertical reveal positioning within a compact machined structure. Streamlined marking assembly 300 may generally comprise main body 311, which defines the structural frame of the device and carries the fastener marking elements. Main body 311 may include one or more hardened marking spikes formed or installed therein, the marking spikes being configured to transfer fastener locations to a cabinet carcass upon application of marking force Fm. These spikes define the precise screw hole locations corresponding to the hinge mounting plate geometry.

Coupled to main body 311 may be rotating support member 341, which may be pivotably mounted relative to main body 311. In certain embodiments, member 341 may be permanently attached to main body 311 via a riveted pivot extending transversely through rotating support member 341, allowing limited rotational movement via rotational force Fr while maintaining structural integrity. Member 341 may provide structural support for threaded adjustment components and may facilitate orientation of assembly 300 relative to a cabinet face or frame. Overlay positioning relative to a cabinet carcass face may be established by threaded overlay adjustment bolt 346. Threaded overlay adjustment bolt 346 may extend through member 341 and/or main body 311 and may include a washer or contact flange configured to engage the front face of a cabinet carcass. By rotating bolt 346 inward or outward under application of rotational force upon rotating bolt 346 (e.g., rotational force Fr), the effective setback distance between main body of assembly 300 and the cabinet face may be adjusted inwardly and/or outwardly according to adjustment force Fa. In certain embodiments, washer portion of bolt 346 may define a broad contact surface configured to distribute contact force against cabinet face FE to improve positional stability during marking. In this manner, bolt 346 functions to “find” or establish the correct overlay distance by advancing until the washer contacts the cabinet face, thereby defining how far back assembly 300 is positioned prior to marking. Once the desired overlay condition is reached, bolt 346 may be held in position by frictional thread engagement. Vertical reveal positioning may be independently established by upper threaded adjustment rod 343 and lower threaded adjustment rod 345, each extending through main body of assembly 300. Adjustment rods 343 and 345 may be selectively rotated to advance or retract relative to cabinet boundaries, thereby defining vertical spacing of marking spikes relative to the top and bottom of a cabinet opening. As illustrated, upper threaded adjustment rod 343 may establish an upper reveal reference R2 relative to a cabinet boundary, while lower threaded adjustment rod 345 may establish a lower reveal reference R1, each independently adjustable to accommodate non-symmetrical reveal conditions. Unlike embodiments using removable reveal blocks, threaded rods 343 and 345 allow continuous fine adjustment of reveal dimension rather than discrete preset values. In certain embodiments of streamlined marking assembly 300, assemblies and/or sub-assemblies may be partially detachable and separate, but be retained by a central rivet transposed through assembly 300 and perpendicular through adjustment rod 345. In such certain embodiments thereof, rotational force Fr may be combined with a force to separate such assemblies and/or sub-assemblies to rotate them about the marking features, thereby further enhancing the ability to, e.g., mark opposite sides of cabinetry carcasses in installations where top and bottom reveals are non-identical. More specifically, in these embodiments, a separation force may be applied to at least a portion of rotating support member 341 relative to main body 311 to permit limited angular displacement about said riveted pivot while maintaining engagement of bolt 346 with cabinet face FE and spacing relative to side panel SP of cabinet carcass C, thereby fixing their positioning and only changing the direction of the calibrated distance (i.e., upper vs. lower).

In operation, assembly 300 may first be positioned adjacent a cabinet carcass. Threaded overlay adjustment bolt 346 may be rotated until its washer contacts the cabinet face, thereby establishing overlay setback. Thereafter, threaded adjustment rods 343 and 345 may be rotated to set vertical reveal positioning relative to upper and lower cabinet boundaries. Once overlay and reveal adjustments are established, actuation force Fa may be applied to main body 311, causing the marking spikes carried by body 311 to transfer fastener locations to the cabinet carcass. Importantly, threaded overlay adjustment bolt 346 and threaded reveal adjustment rods 343 and 345 may be independently adjustable. This allows different vertical reveal settings to be established for upper and lower hinge locations where necessary, such as in installations where a drawer front is positioned above a cabinet door and asymmetric gaps are desired by operation of rotational force Fr in partially separable riveted iterations as described above. In certain embodiments, after establishing a first reveal condition at a lower boundary using rod 345 (R1), assembly 300 may be repositioned and rod 343 adjusted to establish a second reveal condition (R2) without altering overlay setback established by bolt 346, thereby maintaining consistent lateral positioning relative to cabinet face FE while permitting vertical reveal variation. In such cases, reveal may be set for a lower hinge location using rods 343 and 345, and subsequently adjusted for an upper hinge location without disturbing overlay setback defined by bolt 346. Accordingly, streamlined marking assembly 300 represents a mechanically distinct embodiment characterized by a threaded overlay setback mechanism (346), independently adjustable vertical reveal rods (343, 345), and marking spikes integrated into main body 311. The interaction between rotating support member 341, overlay adjustment bolt 346, and independently adjustable reveal rods 343 and 345 enables controlled positioning relative to both cabinet face FE and cabinet side panel SP while permitting selective rotational adjustment about said riveted pivot. This embodiment reduces reliance on modular spacer components and sliding assemblies, while permitting precise overlay and reveal adjustment through threaded mechanical control. The structure may be particularly suitable for machined-metal construction and professional-grade durability.

Referring now to FIG. 8, therein is illustrated a flow diagram of method 800 for accurately marking fastener placement for a cabinetry carcass installation using any of the marking assemblies described herein, including marking system assembly 100, expanded marking assembly 200, and streamlined marking assembly 300. While individual structural embodiments differ in mechanical implementation, the operational methodology may follow substantially similar logical steps. At step 801 (Hinge Selection and Reference Establishment), a hinge or mounting plate configuration is selected. A reference relationship between the hinge fastener pattern and the marking assembly is established. In embodiments 100 and 200, this may include aligning hinge fastener openings with marking projection pins 131 and positioning adjustable marking guide blocks 121 accordingly. In embodiment 300, this may include confirming alignment between hinge fastener spacing and the fixed spike locations carried by main body 311. At step 802 (Lateral Fastener Pattern Calibration), the marking interface is configured to correspond to the selected hinge fastener spacing. In assemblies 100 and 200, this may involve sliding adjustable marking guide blocks 121 along primary alignment body 111 and securing them in position. In assembly 300, this step may be inherent to the fixed spike geometry of body 311, requiring no lateral adjustment. At step 803 (Overlay and Reveal Calibration), overlay setback and vertical reveal positioning are established relative to a cabinet carcass. In assembly 100, reveal selection member 181 and spacing members 141 and 142 may be used to define boundary-referenced offsets. In assembly 200, extension body 201 may be translated along rail guides to establish backset distance. In assembly 300, threaded overlay adjustment bolt 346 may be rotated until its washer contacts the cabinet face, thereby defining overlay setback, and threaded adjustment rods 343 and 345 may be adjusted to establish vertical reveal spacing. At steps 804a-b, the calibrated marking assembly is positioned against the cabinet carcass such that a boundary reference (e.g., upper or lower) is engaged. The device is pressed into engagement with the cabinet surface. Actuation force Fa may applied to the marking assembly, causing marking elements (e.g., marking projection pins 131, hardened spikes in body 311, or equivalent marking structures) to transfer fastener locations to the cabinet carcass. At step 805 (Upper Hinge Positioning), the marking assembly is repositioned relative to an upper cabinet boundary while maintaining calibrated overlay and reveal settings. Where differing upper and lower reveal dimensions are required (such as in drawer-over-door configurations) reveal adjustment may be selectively modified prior to marking the upper hinge location without disturbing fastener spacing calibration. At step 806 (Repeat Application), steps 804a-805 may be repeated across additional cabinet carcasses without recalibration of fastener spacing. Once overlay and reveal parameters are established, multiple cabinet openings may be marked efficiently and consistently.

Method 800 therefore provides a boundary-referenced, repeatable hinge marking process adaptable across multiple mechanical implementations. Whether employing sliding calibration members, extension rails, rotational indexing structures, or threaded adjustment mechanisms, the underlying method emphasizes (i) hinge reference establishment, (ii) overlay and reveal calibration, and (iii) repeatable marking transfer relative to cabinet boundaries.

The illustrations described herein are intended to provide a general understanding of the structure and operation of various embodiments of the boundary-referenced marking systems disclosed. The drawings are not intended to serve as a complete description of all structural configurations, component variations, or methods of manufacture that may fall within the scope of the disclosure. Many additional embodiments may be apparent to those of ordinary skill in the art upon review of the present specification. Structural substitutions, dimensional variations, material changes, mechanical refinements, and logical reconfigurations may be made without departing from the spirit and scope of the disclosure. The drawings are diagrammatic and may not be drawn to scale. Certain proportions may be exaggerated for clarity of explanation, while others may be minimized. Accordingly, both the written description and the accompanying drawings are to be regarded as illustrative rather than restrictive.

As contemplated herein, marking system assembly 100, expanded marking assembly 200, and streamlined marking assembly 300 may be manufactured in a variety of sizes, configurations, and material compositions to accommodate differing cabinetry types, hinge geometries, overlay conditions, reveal specifications, and installation environments. The systems described may be configured for use with frameless cabinetry, face-frame cabinetry, inset doors, partial-overlay doors, full-overlay doors, front-mounted hinge systems, concealed European-style hinges, traditional exterior-mounted hinges, single-screw mounting plates, dual-screw mounting plates, handle and pull hardware, knob installations, and other hardware arrangements known in the cabinetry arts. While specific hinge families and configurations are discussed for illustrative purposes, the disclosure is not limited to any particular manufacturer, mounting standard, or screw pattern.

The disclosed systems may be manufactured using injection-molded polymers, reinforced polymers such as glass-filled nylon, machined metals, brass rail elements, hardened steel marking components, threaded adjustment rods, composite materials, or combinations thereof. Certain embodiments may utilize riveted joints, ball catches, detent indexing features, threaded engagement, friction-fit couplings, or magnetic retention mechanisms. Alternative material selections, fastening approaches, or structural simplifications may be employed to optimize manufacturability, durability, cost efficiency, or field serviceability. Modular kits may include interchangeable reveal selection members, backset spacers, rail extensions, marking elements, or hardware-specific adapters.

The method steps described herein, including those illustrated in method 800, may be performed in varying sequences depending on hinge type, overlay condition, reveal configuration, or installer preference. Merely listing or numbering method steps does not require performance in any particular order unless expressly stated. Certain steps may be omitted, combined, repeated, or modified depending on the embodiment employed. For example, lateral fastener calibration may be adjustable in some embodiments and fixed in others; overlay setback may be established via removable spacers, sliding rails, or threaded rotational members; and reveal spacing may be set independently at upper and lower boundaries where differing vertical conditions are present, such as drawer-over-door installations.

Although specific structural elements and part numbers have been described for clarity and reference, it is to be understood that equivalent structures performing substantially the same function in substantially the same way to achieve substantially the same result are contemplated within the scope of the disclosure. Terminology used herein is descriptive rather than limiting. Various adaptations, refinements, and alternative configurations will become apparent to those having ordinary skill in the cabinetry installation and hardware alignment arts in view of the teachings presented.

Accordingly, while particular embodiments of the boundary-referenced marking systems and associated methods have been described in detail, it should be understood that the disclosure is not limited to the specific configurations illustrated and described. Rather, the scope of protection is defined by the appended claims and their equivalents.

1. A system for accurately marking a fastener placement for a cabinetry carcass of a cabinetry installation, said cabinet carcass having an at least one guide region defined between an upper boundary and a lower boundary, the system comprising:
a primary alignment body configured to be positioned against the cabinet carcass within the at least one guide region;
a pair of adjustable marking guide blocks movably coupled to said primary alignment body and independently adjustable relative to one another along a longitudinal axis of said primary alignment body;
a marking projection pin carried by each adjustable marking guide block and configured to transfer a fastener location to a cabinet surface when said primary alignment body is pressed thereagainst;
an upper spacing member removably coupled to said primary alignment body and configured to establish a first vertical reference offset relative to one of the upper boundary and the lower boundary of the cabinet carcass; and
a lower spacing member removably coupled to said primary alignment body at a location spaced from upper spacing member and configured to cooperate with said upper spacing member to establish a repeatable vertical distance between the upper boundary and the lower boundary;
wherein said placement of said primary alignment body with at least one of said upper spacing member and said lower spacing member abutting a corresponding boundary enables a consistent repeated transfer of fastener locations by said marking projection pins across multiple cabinet carcasses without re-measurement.

2. The system of claim 1, wherein said primary alignment body includes an alignment indicia comprising an engraved alignment scale extending along a longitudinal axis thereof and including a centerline indicator configured to align with a corresponding centerline of a cabinet hinge.

3. The system of claim 2, wherein said upper spacing member and said lower spacing member each include an engagement surface configured to abut an edge of the cabinet carcass to establish said first and second vertical reference offsets and said repeatable vertical distance.

4. The system of claim 3, further comprising at least one reveal selection member selectively positionable between said primary alignment body and said cabinet carcass to establish a predetermined overlay distance corresponding to a cabinet hinge specification.

5. The system of claim 1, further comprising a slidable extension body movably coupled to said primary alignment body and configured to extend a marking reach relative to the cabinet carcass.

6. The system of claim 5, further comprising at least one linear guide rail secured to said primary alignment body and configured to guide translational movement of said slidable extension body.

7. The system of claim 5, further comprising an extension locking fastener knob configured to selectively fix a relative position of said slidable extension body with respect to said primary alignment body.

8. The system of claim 5, further comprising at least one extension spacing member configured to establish a backset distance between said primary alignment body and a hinge mounting plate.

9. The system of claim 5, wherein said slidable extension body is configured to accommodate at least one of:
(a) face-frame cabinetry installations,
(b) inset door hinge installations, and
(c) full-overlay hinge configurations.

10. The system of claim 5, wherein said slidable extension body and said primary alignment body cooperate to permit adjustment of a hinge mounting location in a direction substantially perpendicular to a plane of the cabinet carcass while maintaining said first and second vertical reference offsets and said repeatable vertical distance.

11. A method for accurately marking a fastener placement for a cabinetry carcass of a cabinetry installation, said cabinet carcass having at least one guide region defined between an upper boundary and a lower boundary, the method comprising:
providing a marking system assembly including a primary alignment body, a pair of adjustable marking guide blocks movably coupled to said primary alignment body, a marking projection pin carried by each adjustable marking guide block, an upper spacing member removably coupled to said primary alignment body, and a lower spacing member removably coupled to said primary alignment body;
adjusting said adjustable marking guide blocks independently relative to one another along a longitudinal axis of said primary alignment body to correspond to a fastener pattern of a cabinet hinge;
positioning said primary alignment body within the at least one guide region of the cabinet carcass such that at least one of said upper spacing member and said lower spacing member abuts a corresponding one of the upper boundary and the lower boundary;
establishing a repeatable vertical distance between the upper boundary and the lower boundary via cooperative positioning of said upper spacing member and said lower spacing member; and
pressing said primary alignment body against the cabinet carcass to cause said marking projection pins to transfer fastener locations to a cabinet surface,
wherein said positioning and pressing steps are repeatable across multiple cabinet carcasses without re-measurement.

12. The method of claim 11, further comprising aligning an alignment indicia of said primary alignment body, including an engraved alignment scale and a centerline indicator, with a corresponding centerline of a cabinet hinge prior to adjusting said adjustable marking guide blocks.

13. The method of claim 12, further comprising abutting engagement surfaces of said upper spacing member and said lower spacing member against respective edges of the cabinet carcass to establish a first vertical reference offset and a second vertical reference offset defining said repeatable vertical distance.

14. The method of claim 13, further comprising selectively positioning at least one reveal selection member between said primary alignment body and said cabinet carcass to establish a predetermined overlay distance corresponding to a cabinet hinge specification.

15. The method of claim 11, further comprising coupling a slidable extension body to said primary alignment body and extending said slidable extension body relative to the cabinet carcass to increase a marking reach.

16. The method of claim 15, further comprising guiding translational movement of said slidable extension body along at least one linear guide rail secured to said primary alignment body.

17. The method of claim 15, further comprising selectively fixing a relative position of said slidable extension body with respect to said primary alignment body using an extension locking fastener knob.

18. The method of claim 15, further comprising establishing a backset distance between said primary alignment body and a hinge mounting plate using at least one extension spacing member.

19. The method of claim 15, wherein said extending and positioning steps are performed to accommodate at least one of:
(a) face-frame cabinetry installations,
(b) inset door hinge installations, and
(c) full-overlay hinge configurations.

20. The method of claim 15, further comprising adjusting said slidable extension body 201 relative to said primary alignment body in a direction substantially perpendicular to a plane of the cabinet carcass while maintaining said first and second vertical reference offsets and said repeatable vertical distance during transfer of said fastener locations.
